(19) United States
(12) Patent Application Publication
(10) Pub. No.: US 2004/0183450 A1
(43) Pub. Date: Sep. 23, 2004

(54) Method and apparatus for determining the resonant frequency of a resonant circuit

(75) Inventors: Olaf Busse, Munchen (DE); Bernhard Schemmel, Wessling (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN mbH, Munchen (DE)

(21) Appl. No.: 10/782,853

(22) Filed: Feb. 23, 2004

(30) Foreign Application Priority Data
Mar. 7, 2003 (DE) 103 10 143.8

(51) Int. Cl. H05B 39/00

(52) U.S. Cl. 315/97; 315/106; 315/209 R

(57) ABSTRACT

The invention intends to improve the determination of the resonant frequency of a resonant circuit, in particular of a heating circuit for a discharge lamp. For this purpose, the frequency of a supply voltage for the resonant circuit is varied within a predetermined frequency range. The voltage or the current across/in the resonant circuit are measured as a function of the varied frequency. The predetermined frequency range is run through in both directions, in each case a maximum for the measured voltage or the measured current being established. The resonant frequency is preferably calculated from the two maxima by averaging.

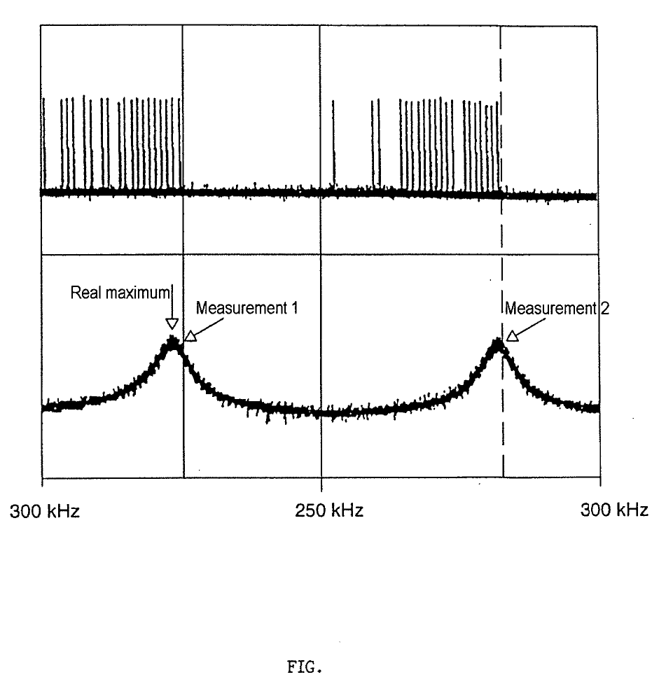

### FIELD OF THE INVENTION

The present invention relates to a method for measuring the resonant frequency of a resonant circuit, in particular of a heating circuit for a discharge lamp, by varying the frequency of a supply voltage for the resonant circuit within a predetermined frequency range, and measuring a voltage or a current across/in the resonant circuit as a function of the varied frequency. Furthermore, the present invention relates to a corresponding apparatus for measuring the resonant frequency.

### BACKGROUND OF THE INVENTION

A discharge lamp is preheated by means of a heating circuit which is operated at resonance. For this purpose, the resonant frequency of the heating circuit must be determined precisely. It depends on the component tolerances of the filament transformer and of the resonant circuit, but also on the filament resistance of the connected lamp.

Furthermore, when determining the resonant frequency, the maximum current or the maximum voltage which occur at resonance is measured. This maximum value can be used to establish the type of lamp connected. An accurate measurement of the resonant frequency is therefore absolutely necessary not only for effective preheating but also for reliably identifying the type of lamp.

In the case of switched-mode power supplies, such as, for example, electronic ballasts, many disturbing influences render the measurement of the maximum by means of an A/D converter more difficult. Although these disturbances can be reduced by means of an optimized printed circuit board layout, they are nevertheless still present and result in the measured maximum not corresponding to the real maximum.

In known methods for measuring the resonant frequency, the frequency range in which the resonant frequency is to be expected is run through once, and the maximum for a measured voltage is determined. The frequency value at which the maximum was measured is then used for the preheating. In order to compensate for systematic disturbances, according to the known method, a fixed offset value is added to the determined frequency or subtracted from it. Systematic faults result, for example, from the filter characteristic of the measurement path and from the different behavior of the resonant circuit above and below the resonant frequency.

Such a method is disclosed in the German laid-open specification DE 100 13 342 A1. In order to generate a starting voltage for fluorescent lamps, the AC voltage is impressed on an LC series resonant circuit over a first time interval with a first initial frequency. After the first time interval, the voltage across the fluorescent lamp is measured and compared with a desired value. When the desired value is achieved, the starting voltage generation is interrupted, a voltage for the normal mode of operation of the fluorescent lamp being applied. These method steps are repeated for an n-th time interval with an n-th initial frequency until the desired value is reached. In this case, the first initial frequency corresponds to as large as possible a value for the resonant frequency which depends on the tolerance of the components involved. The n-th initial frequency corresponds to as small as possible a value for the resonant frequency which depends on the tolerance of the components involved. Each n-th initial frequency is smaller than its preceding initial frequency. By varying the initial frequency of the AC voltage, which is applied to the LC series resonant circuit, the potential tolerance range of the resonant frequency is “run through”, until the required value for a starting voltage for the fluorescent lamp is reached. This prevents a starting voltage from being produced which is too low as a result of the lack of resonance and prevents a situation arising in which the lamp does not start. As already mentioned above, this determination of the resonant frequency when running through the frequency range is relatively inaccurate.

### SUMMARY OF THE INVENTION

It is therefore the object of the present invention to make possible a more precise determination of the resonant frequency for the preheating circuit of a discharge lamp.

This object is achieved according to the invention by a method for measuring the resonant frequency of a resonant circuit, in particular of a heating circuit for a discharge lamp, by varying the frequency of a supply voltage for the resonant circuit within a predetermined frequency range, and measuring a voltage or a current across/in the resonant circuit as a function of the varied frequency, the predetermined frequency range being run through in both directions, in the process a maximum for the measured voltage or the measured current being established in each case, and the resonant frequency being determined from the two maxima.

The invention also provides for a corresponding apparatus for measuring the resonant frequency of a resonant circuit, in particular of a heating circuit for a discharge lamp, by a supply device for supplying the resonant circuit with a supply voltage, whose frequency can be varied within a predetermined frequency range, and a measuring device for measuring a voltage or a current across/in the resonant circuit as a function of a frequency, it being possible to run through the frequency of the supply voltage in the predetermined frequency range at least once in both directions, and, in the process, to measure in each case a maximum for the voltage or the current, and to determine the resonant frequency from the two maxima with the aid of a determining device.

By running through the frequency range in both directions, systematic faults in the determination of the resonant frequency can be minimized. Systematic faults then result only from the increment of the change in frequency when running through the frequency range.

If the frequency range of the AC voltage for the preheating is run through, starting from a highest frequency to a lowest, or vice versa, and then back again, the maxima can be determined in one measurement step.

The resonant frequency is preferably determined by averaging the two frequencies, at which in each case a maximum is established, and by this value being interpreted as the actual resonant frequency. In order to improve reliability when determining the resonant frequency, even more maxima can be determined in two or more runs through the frequency range, and from this, in turn, the average value can be formed.

A maximum can be determined by a measured value being stored when this measured value is higher than the preceding one. This makes it possible to determine a maximum in a relatively simple manner, with any desired accuracy and as a function of the size of the frequency steps.

### BRIEF DESCRIPTION OF THE DRAWINGS

The present invention is now explained in more detail with reference to the attached drawing which shows measurement signals for determining the maxima.

### DETAILED DESCRIPTION OF THE INVENTION

The embodiment described below is a preferred exemplary embodiment of the present invention. According to the invention, the frequency range of the resonant circuit, in which the resonant frequency is expected, is run through, starting from the highest frequency, for example 300 kHz, down to the lowest frequency, for example 250 kHz, and then back to the highest frequency. This is illustrated by the measurement curve in the lower part of the figure. The measurement curve shows the measurement behavior over time. Here, the frequency is reduced at a predetermined rate up to the middle of the drawing, and then increased again. The real maximum is passed through in both measurement sections.

In order to determine the maximum by measuring, a measured value is recorded when this measured value is higher than a preceding measured value. The signal in the upper half of the figure shows this storage step. A value is stored at each peak. Since the signal (see lower half of the figure) is noisy, the interval between the storage steps is sometimes irregular, although the ideal signal initially increases continuously in the first measurement phase. The maximum is given by the last stored value. In the first measurement run, this value is characterized by a vertical line (measurement 1). It can be seen from the drawing that the measured value determined in this way, based on the frequency, is below the real maximum.

In the subsequent second measurement phase, in which the frequency is increased again stepwise, the amplitude of the measured signal initially also increases. This can also be seen from the signal above. Here too, the peaks indicate the points in time at which a higher measured value is stored. The second measurement results in a frequency value which is indicated in the drawing by a dashed vertical line and is above the real maximum.

In order to evaluate the measurement result, the two measured values of measurement 1 and measurement 2 are averaged, giving an average, computed maximum. It is highly probable that this computed maximum is very close to the real maximum.

By averaging the two maxima, the abovementioned disturbing influences are largely blanked out, such that the calculated average is very close to the real maximum.

1. A method for measuring the resonant frequency of a resonant circuit, in particular of a heating circuit for a discharge lamp, by
varying the frequency of a supply voltage for the resonant circuit within a predetermined frequency range,
measuring a voltage or a current across/in the resonant circuit as a function of the varied frequency,
running through the predetermined frequency range is in both directions,
in the process a maximum for the measured voltage or the measured current is established in each case, and the resonant frequency is determined from the two maxima.

2. The method as claimed in claim 1, in which, when varying the frequency of the supply voltage, the frequency range is run through, starting from the highest frequency to the lowest, or vice versa, and then back again.

3. The method as claimed in claim 1, in which the resonant frequency is determined by averaging the two frequencies, at which in each case a maximum is established.

4. The method as claimed in claim 1, in which a maximum is determined by a measured value being stored when this measured value is higher than the preceding one.

5. An apparatus for measuring the resonant frequency of a resonant circuit, in particular of a heating circuit for a discharge lamp, having
a supply device for supplying the resonant circuit with a supply voltage, whose frequency can be varied within a predetermined frequency range, and
a measuring device for measuring a voltage or a current across/in the resonant circuit as a function of a frequency,
whereby it is possible to run through the frequency of the supply voltage in the predetermined frequency range at least once in both directions, and, in the process, to measure in each case a maximum for the voltage or the current, and
to determine the resonant frequency from the two maxima with the aid of a determining device.

6. The apparatus as claimed in claim 5, in which, with the supply device, the frequency range of the supply voltage can be run through, starting from the highest frequency to the lowest, or vice versa, and then back again.

7. The apparatus as claimed in claim 5, in which an average for the two frequencies, at which in each case a maximum is established, can be determined as the resonant frequency with the aid of the determining device.

8. The apparatus as claimed in one of claims 5, in which the measuring device comprises a storage device which can be used to store a measured value for determining a maximum when this measured value is higher than the preceding measured value.
